(19) United States
(12) Patent Application Publication
(10) Pub. No.: US 2004/0201614 A1
(43) Pub. Date: Oct. 14, 2004

(54) Apparatus and method of visiting bookmarked web pages without opening a bookmark folder

(75) Inventors: Denise Marie Genty, Austin, TX (US); Shawn Patrick Mullen, Buda, TX (US); Johnny Meng-Han Shieh, Austin, TX (US); James Stanley Tesauro, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/981,878

(22) Filed: Oct. 18, 2001

(51) Int. Cl. G09G 5/00; G06F 17/24

(52) U.S. Cl. 345/738; 715/501.1; 715/526

(57) ABSTRACT

A method, system and apparatus for accessing bookmarked Web pages without opening a bookmark folder are provided. This is made possible by providing a next and a previous icon in the browser to access the bookmarked Web pages. When a Web page is being bookmarked, it can be chosen to be part of a route (i.e., a string of bookmarks to be successively accessed) or not. If it is part of a route, the bookmarked Web page may be accessed without opening the bookmark folder by using either the next or the previous icon.

### BACKGROUND OF THE INVENTION

1. Technical Field

The present invention is directed to a communications network. More specifically, the present invention is directed to a method and apparatus of visiting a series of bookmarked Web pages.

2. Description of Related Art

As is well known by now, the World Wide Web (WWW) or Internet is a system of servers that support documents formatted in Hyper Text Markup Language (HTML). HTML supports links to documents as well as to graphics, audio and video files. Links are references to documents from within other documents. Links allow a user to easily jump from one document or Web page to another with just a click of a mouse. Thus, a link is a very useful Internet navigational tool.

Another useful Internet navigational tool is a bookmark. A bookmark is a feature that is available in most Web browsers that allows a user to save addresses or URLs (abbreviation for Uniform Resource locators) of web pages into a folder (i.e., a bookmark folder) for later re-visitation. A web browser is a software application that is used to locate and display web pages. U.S. Pat. No. 6,037,944 issued to Himmel et al. and entitled NAMED BOOKMARK SETS as well as U.S. Pat. No. 6,208,995 B1 issued to the same inventors and entitled WEB BROWSER DOWNLOAD OF BOOKMARK SET describe how a bookmark is downloaded into a bookmark folder. The description in both patents is herein incorporated.

When a user accesses a Web page that may later be re-visited, the user may bookmark the page (i.e., store the URL of the Web page in a bookmark folder). Thus, Web pages that are visited daily are ordinarily bookmarked. However, each time a user wants to re-visit each one of these bookmarked Web pages, the user has to pull down the bookmark folder to display a list of the bookmarked Web pages. Once the list is displayed, the user selects which one of the bookmarked Web pages to access. After making the selection, the user, to access the bookmarked Web page, has to double click (with the aid of a mouse) on the bookmarked Web page.

This method of accessing bookmarked Web pages is fine so long as a user is randomly accessing bookmarked Web pages. But, if a user consistently accesses a series of bookmarked Web pages every day, this method becomes quickly very cumbersome. Of course, the greater the number of bookmarked Web pages to be visited daily, the more cumbersome the method.

Hence, what is needed is a method and apparatus that allow a user to successively access a series of bookmarked Web pages without opening the bookmark folder.

### SUMMARY OF THE INVENTION

The present invention provides a method, system and apparatus for accessing bookmarked Web pages without opening a bookmark folder. The invention uses a next and a previous icon to access the bookmarked Web pages. When a Web page is being bookmarked, it can be chosen to be part of a route (i.e., a string of bookmarks to be successively accessed) or not. If it is part of a route, the bookmarked Web may be accessed without opening the bookmark folder by using either the next or the previous icon.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a representative graphical user interface (GUI) of a Web browser.

FIG. 5 is a typical bookmark folder.

FIG. 6 depicts a GUI for bookmarking a Web page.

FIG. 7 depicts a GUI for bookmarking a Web page used by the present invention.

FIG. 8 depicts a GUI used by the present invention.

FIG. 9 depicts a bookmark folder used by the present invention.

FIG. 10 is flow diagram of a process used by the present invention.

### DETAILED DESCRIPTION OF THE PREFERRED EMBODIMENT

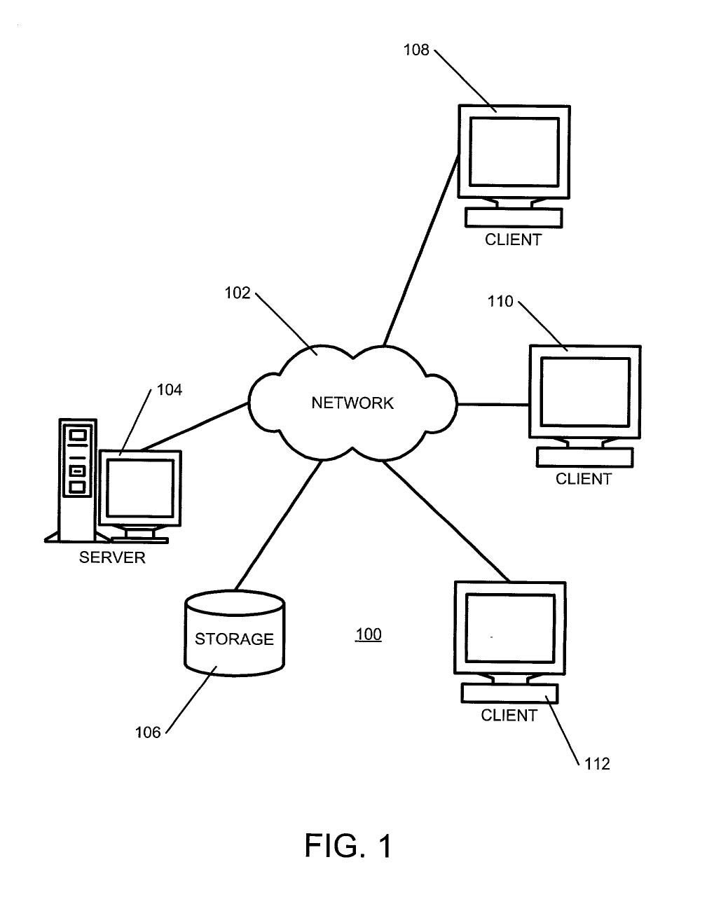

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

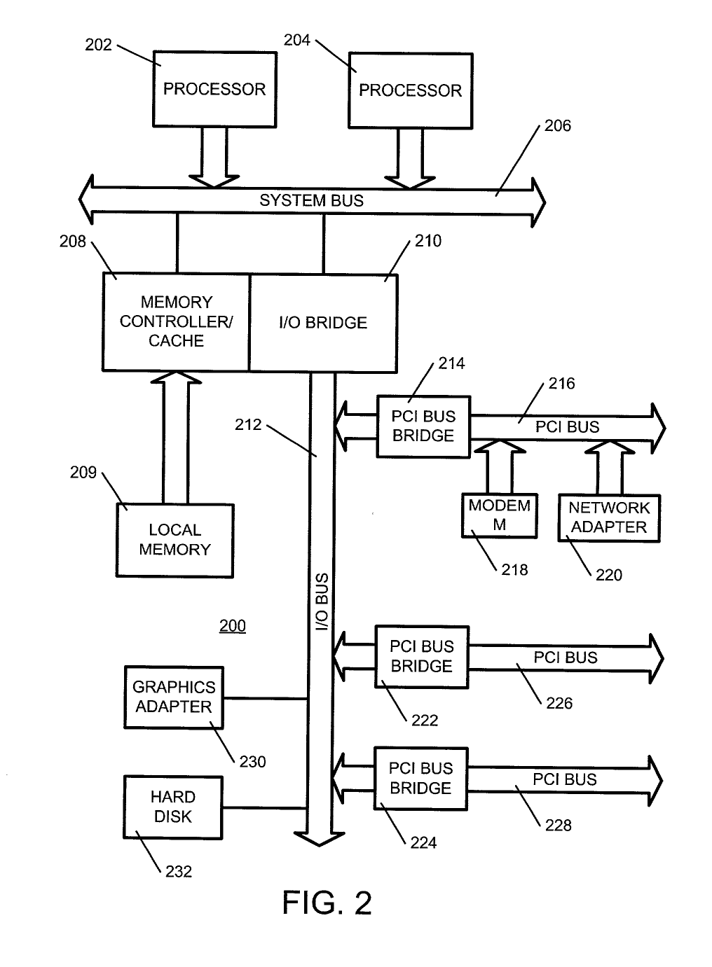

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

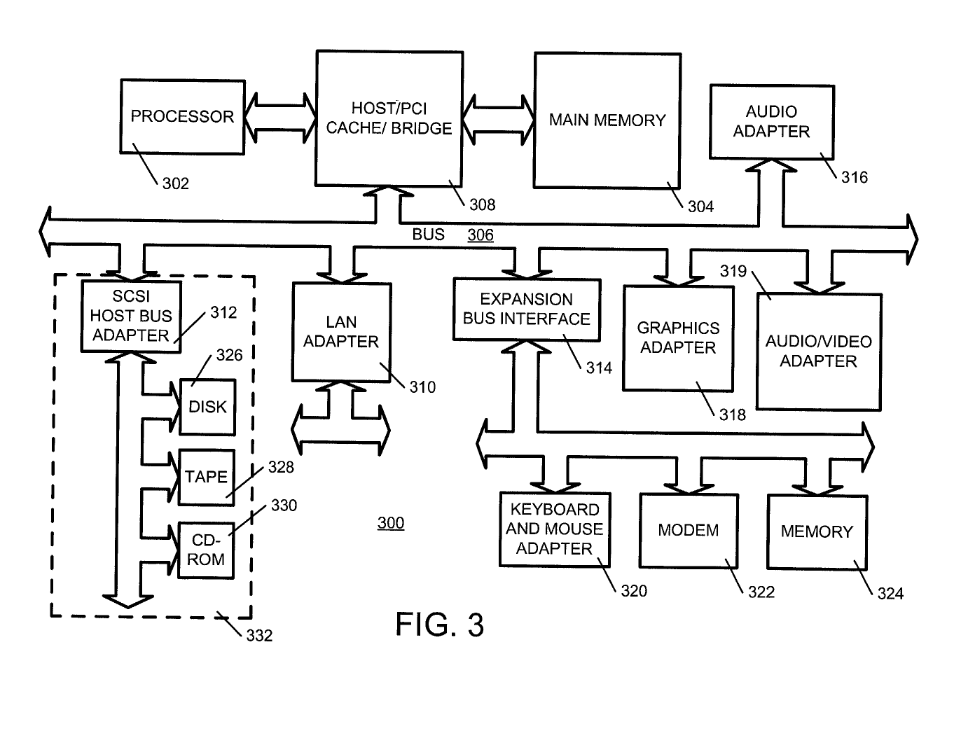

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method that allow a user to access a series of bookmarked Web pages without pulling down the bookmark folder and double click on the bookmarked Web page that is to be accessed. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

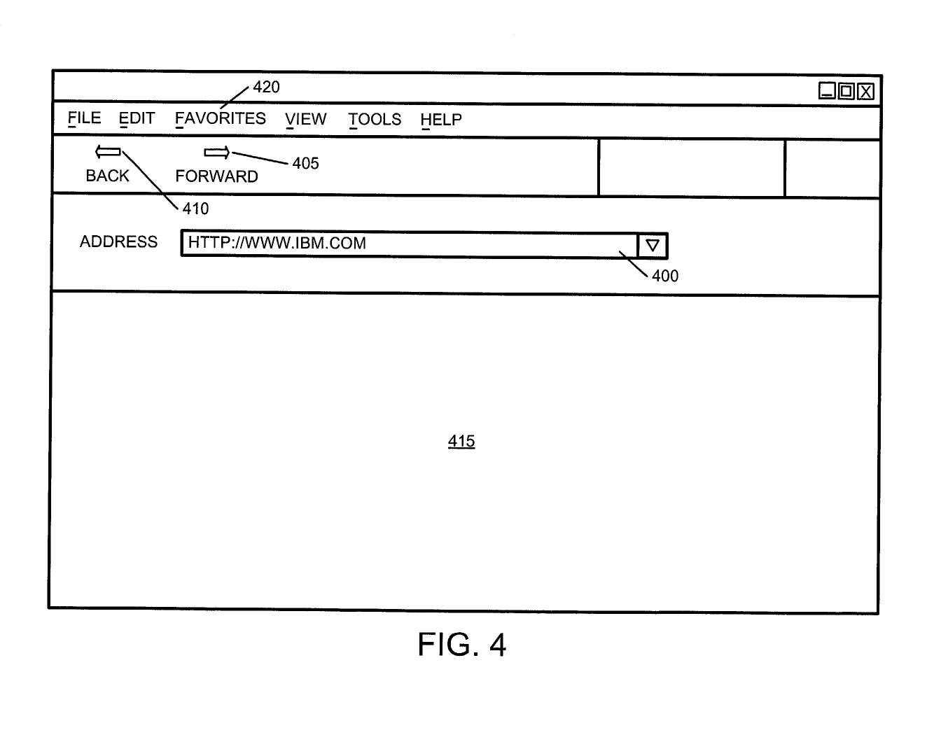

FIG. 4 is a representative graphical user interface (GUI) of a Web browser. Not all items in the GUI are shown and only the items of importance to the invention are given a reference numeral. When a Web browser is activated and a Web page is accessed, the content of the page is displayed in area 415, the address or URL of the page is displayed in address box 400. Back arrow 410 and forward arrow 405 are not live (i.e., a user cannot assert them to get to a Web page). If another Web page is accessed, the URL of the displayed page will be displayed in address box 400 and the content in area 415. The back arrow 410 will become live. If the user asserts back arrow 410, the previous page will be re-displayed along will its pertinent information (i.e., URL, content etc.). At that time, forward arrow 405 will become live, back arrow 410 will not be live. If a user accesses three different Web pages successively, and while the third page is displayed returns to the second page using the back arrow 410, both back arrow 410 and forward arrow 405 will be live. The user may assert back arrow 410 to re-display the first Web page or forward arrow 405 to re-display the third Web page. This is made possible by caching or storing the URLs in a memory device (not shown) in the order the Web pages were accessed. Note that, if a new Web page is accessed while the second Web page is displayed, the URL of the new page will be cached replacing the URL of the third page. Caching URLs of Web pages is a well-known art and is thus not explained.

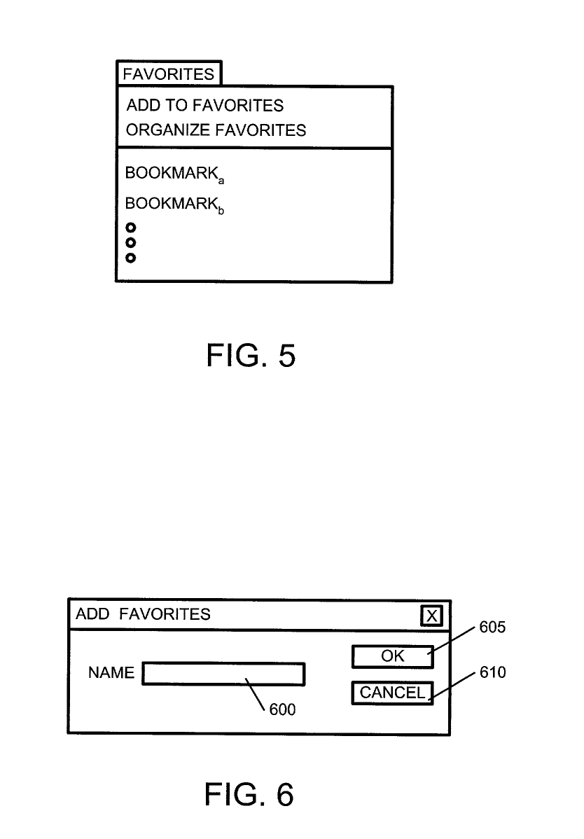

To bookmark a page, the bookmark folder has to be opened. In Netscape Navigator, a user has to click once on a bookmark icon and in Internet Explorer the user has to click once on a Favorites icon to open the bookmark folder. In this particular example, Internet Explorer is used. However, it should be understood that any other Web browser having the bookmark feature may be used with the invention. In any case, when the bookmark folder is opened, FIG. 5 is displayed. When a user asserts “add to Favorites”, FIG. 6 is displayed. In name box 600 is displayed a default name associated with the URL. If the user so wants, the user may replace the default name by another name of the user's liking. When done, ok button 605 can be asserted to bookmark the page, or cancel button 610 can be asserted to close the FIG. 6 without bookmarking the page.

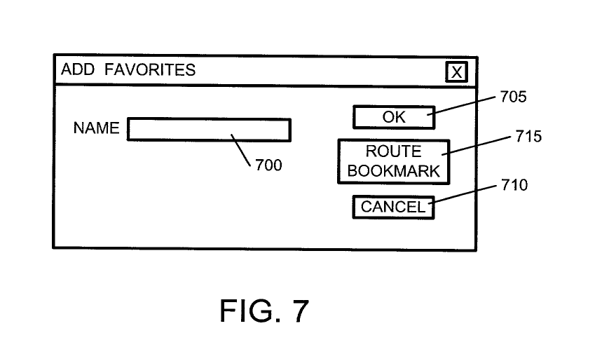

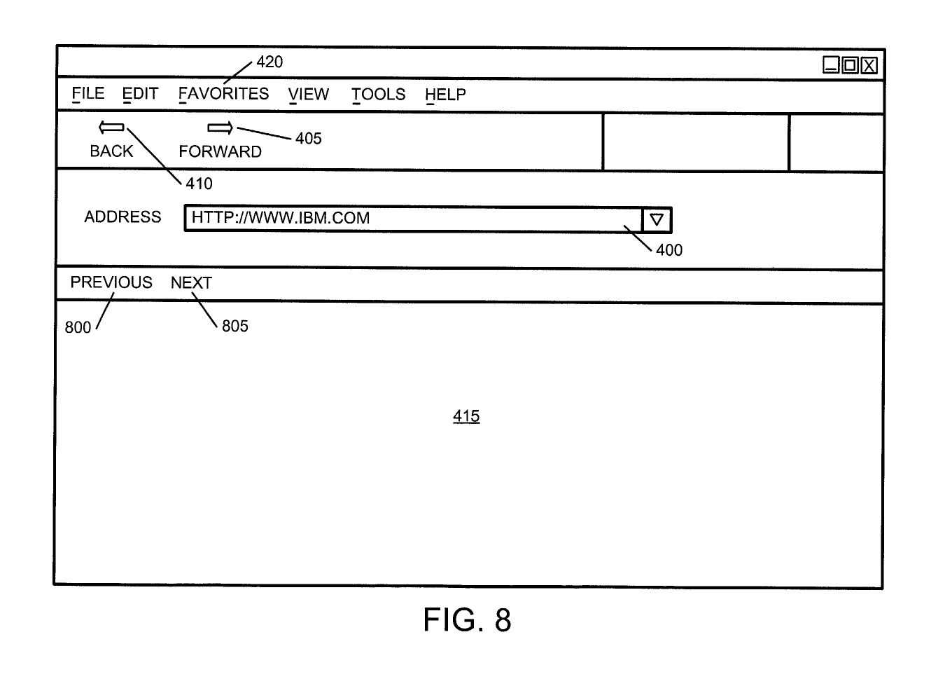

FIG. 7 is a depiction of FIG. 6 with an added function. The added function is a route bookmark function that can be accessed using route bookmark button 715. Name box 700, ok button 705 and cancel button 710 have the same purpose as name box 600, ok button 605 and cancel button 610 in FIG. 6. When the user asserts route bookmark button 715, the URL of the Web page is stored into a list of URLs that can be accessed without opening the bookmark folder. FIG. 8 is a GUI used by the present invention that allows a user to access bookmarked Web pages without first opening the bookmark folder.

Shown in FIG. 8 are previous icon 800 and next icon 805 added to FIG. 4. When the browser is first activated, previous icon 800 is not live but next icon 805 is and most probably the home page is displayed. If the user asserts the next icon 805, the first Web page to be bookmarked as a route bookmark is accessed. At that moment, the previous icon 800 becomes live (i.e. the user may assert the previous icon 800 to return to the route bookmarked previously displayed). Of course, the back arrow 410 and the forward arrows 405 will work as usual. That is, a user instead of asserting the previous icon 800 may assert the back arrow 410 to return to a previously visited Web page. In this case, this would be the previously visited route bookmarked Web page. Likewise, a user may assert the forward arrow to re-access a Web page.

The route bookmarked Web pages are accessed in the order they were bookmarked and based on which one of the route bookmarked Web page has last been accessed when the previous icon 800 and the next icon 805 are asserted. Thus, a user while displaying a route bookmarked Web page may access any other Web page. But when the previous icon 800 is asserted, the route bookmarked Web page that was displayed before the last displayed route bookmarked Web page will be re-accessed. Similarly, when the next icon 805 is asserted, the route bookmarked Web page that comes after the lastly displayed route bookmarked Web page will be accessed.

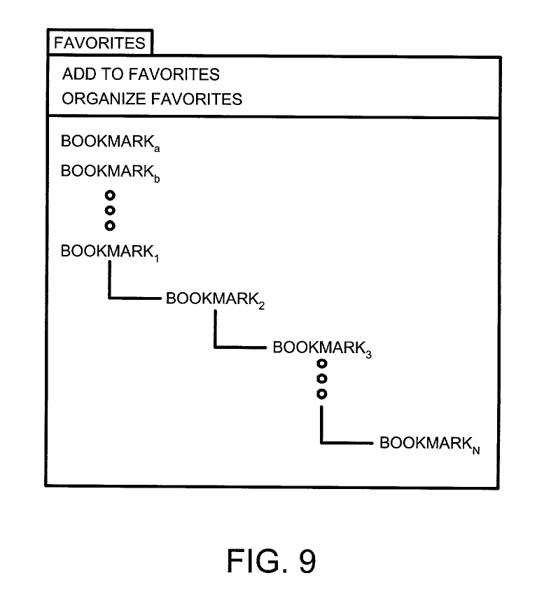

FIG. 9 is a display of the bookmark folder in accordance with the present invention. When the bookmark folder is accessed, a list of the Web pages bookmarked is displayed. Bookmarkₐ, bookmark_{b} . . . is a list of regular bookmarked Web pages. Bookmark₁, bookmark₂, bookmark₃ . . . bookmark_{N} is a list of a route of bookmarks, where 1<=N<=number of bookmarked Web pages in the route. When the next icon 805 is asserted for the first time, bookmark₁ will be accessed and displayed. The second time the next icon is asserted, bookmark₂ will be accessed and displayed and so on. If bookmark₃ was last displayed and the previous icon 800 is asserted, bookmark₂ will be displayed etc. If a user ever wants to change the order in which the bookmarked web pages in the route are accessed and displayed, the user needs only change the order of the bookmarked Web pages in the route using, for example, the cut and paste feature of the browser.

One of the benefits of the invention is that it allows a smart Web browser to pre-fetch the next bookmarked Web page in the route. Thus, less time is spent accessing and displaying the pages. Another benefit of the invention is that far fewer mouse/key operations are required to visit the pages and no mistakes will be made while navigating through the route. A further benefit is that a user is guaranteed to visit every page in the route.

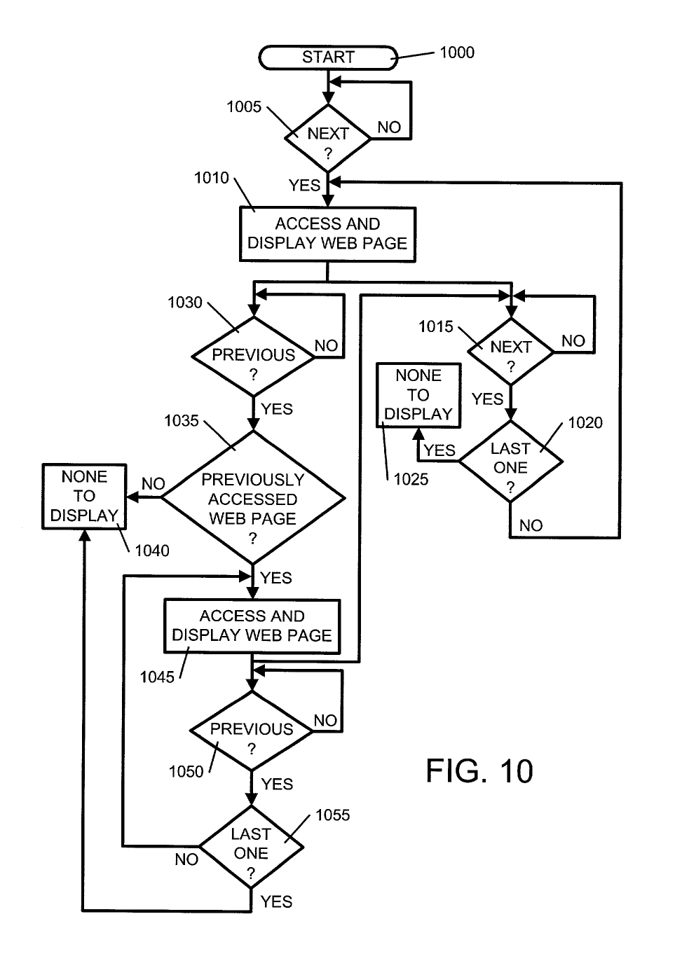

FIG. 10 is a flow diagram of a process used by the present invention. The process starts as soon as the Web browser is activated (step 1000). A check is continuously being made to determine whether the next icon is asserted (step 1005). Note that when the Web browser is first activated, the previous icon 800 will not be live and thus it is not necessary that a check be made to determine whether it is asserted. Moreover, if there is not a bookmarked Web page stored in the route, the next icon 805 will not be live either. If the next icon 805 is asserted, the first bookmarked Web page in the route will be accessed and displayed (step 1010). At that point, two checks will continuously be made. The first continuous check is to determine whether the next icon 805 is again asserted. If so, a check will be made to determine whether the presently displayed Web page or the last displayed bookmarked Web page in the route is the last one in the route. If so, an error such as “none to display” will be generated (steps 1015, 1020 and 1025). If the presently displayed bookmarked Web page or the last displayed bookmarked Web page in the route is not the last one in the route, the process will return to step 1010 (steps 1015, 1020 and 1010).

The second continuous check is to determine whether the previous icon 800 is asserted. If so, another check will be made as to whether a bookmarked Web page in the route was previously accessed. If a bookmarked Web page in the route was not previously accessed, then an error such as “none to display” will be generated (steps 1030, 1035 and 1040). If a bookmarked Web page in the route was previously accessed then it will be re-accessed and displayed (steps 1030, 1035 and 1045). At that point in the process, two checks will again be continuously made. The first check is to determine whether the next icon 805 is asserted. If so, the process will return to step 1015. The second check is to determine whether the previous icon 800 is asserted. If so, another check will be made as to whether the presently displayed web page or the last bookmarked Web page to be accessed in the route was the first one displayed in the route. If so, an error message such as “none to display” will be generated (steps 1050, 1055 and 1040). If not, the process will return to step 1045.

Although the invention is disclosed using one bookmark route, a user may have as many bookmark routes as desired. In this case, the user may have to name each bookmark route. Thus, when the bookmark folder is opened, the name of the routes will be displayed as regular bookmarks. Alternatively, they may be highlighted in some fashion as an indication that they are bookmark routes. In any case, when the user clicks on one of the route bookmarks, then the chain of bookmarks for that route will be displayed. To navigate through that bookmark route, the user needs only click on one of the bookmarked Web pages in the route. After accessing and displaying the bookmarked Web page, the user may use the previous icon 800 and the next icon 805 to access the other bookmarked Web pages in the route. When the user wants to navigate through another route, the user may simply open the bookmark folder and click on another route. When the string of the bookmarked Web pages for that route is displayed, the user may click on one of the bookmarked Web pages to access and display that page. Then, as before, the user may use the previous icon 800 and the next icon 805 to access the other bookmarked Web pages in the new route.

The description of the present invention has been presented for purposes of illustration and description, and is not intended to be exhaustive or limited to the invention in the form disclosed. Many modifications and variations will be apparent to those of ordinary skill in the art. For example, more than one background search may be performed with the invention. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of accessing and displaying bookmarked web pages upon a browser activation without opening a bookmark folder within which said bookmarked Web pages are contained comprising the steps of:
activating said browser, said browser having at least one icon, said at least one icon being associated with one of said bookmarked web pages; and
asserting said at least one icon for accessing and displaying said one of said bookmarked Web pages.

2. The method of claim 1 wherein said bookmarked web pages are accessed and displayed in the order bookmarked.

3. The method of claim 2 wherein the bookmarked Web pages are displayed in the bookmark folder as a chain of bookmarked Web pages.

4. The method of claim 3 wherein the at least one icon is a next icon.

5. The method of claim 4 wherein a previous icon may be used to access the bookmarked web pages.

6. A computer program product on a computer readable medium for accessing and displaying bookmarked web pages upon a browser activation without opening a bookmark folder within which said bookmarked Web pages are contained comprising:
code means for activating said browser, said browser having at least one icon, said at least one icon being associated with one of said bookmarked web pages; and
code means for asserting said at least one icon for accessing and displaying said one of said bookmarked Web pages.

7. The computer program product of claim 6 wherein said bookmarked web pages are accessed and displayed in the order bookmarked.

8. The computer program product of claim 7 wherein the bookmarked Web pages are displayed in the bookmark folder as a chain of bookmarked Web pages.

9. The computer program product of claim 8 wherein the at least one icon is a next icon.

10. The computer program product of claim 9 wherein a previous icon may be used to access the bookmarked web pages.

11. An apparatus for accessing and displaying bookmarked web pages upon a browser activation without opening a bookmark folder within which said bookmarked Web pages are contained comprising:
means for activating said browser, said browser having at least one icon, said at least one icon being associated with one of said bookmarked web pages; and
means for asserting said at least one icon for accessing and displaying said one of said bookmarked Web pages.

12. The apparatus of claim 11 wherein said bookmarked web pages are accessed and displayed in the order bookmarked.

13. The apparatus of claim 12 wherein the bookmarked Web pages are displayed in the bookmark folder as a chain of bookmarked Web pages.

14. The apparatus of claim 13 wherein the at least one icon is a next icon.

15. The apparatus of claim 14 wherein a previous icon may be used to access the bookmarked web pages.

16. A computer system for accessing and displaying bookmarked web pages upon a browser activation without opening a bookmark folder within which said bookmarked Web pages are contained comprising:
at least one memory device for storing code data; and
a processor for processing said code data to activate said browser, said browser having at least one icon, said at least one icon being associated with one of said bookmarked web pages, and to assert said at least one icon for accessing and displaying said one of said bookmarked Web pages.

17. The computer system of claim 16 wherein said bookmarked web pages are accessed and displayed in the order bookmarked.

18. The computer system of claim 17 wherein the bookmarked Web pages are displayed in the bookmark folder as a chain of bookmarked Web pages.

19. The computer system of claim 18 wherein the at least one icon is a next icon.

20. The computer system of claim 19 wherein a previous icon may be used to access the bookmarked web pages.
